(19) United States
(12) Patent Application Publication
(10) Pub. No.: US 2026/0031377 A1
(43) Pub. Date: Jan. 29, 2026

(54) METHOD AND SYSTEM FOR STORING GRID ELECTRICITY AND DISPENSING THE STORED ELECTRICITY ON DEMAND

(71) Applicant: Epro Advance Technology Limited, Hung Hom, Kowloon (HK)

(72) Inventors: Albert Pui Sang LAU, Kowloon (HK); Wey Yang TEOH, Kowloon (HK); Chen BING, Kowloon (HK)

(21) Appl. No.: 18/994,542

(22) PCT Filed: Jul. 13, 2023
(86) PCT No.: PCT/IB2023/057173

§ 371 Date: Jan. 14, 2025

(30) Foreign Application Priority Data
Jul. 14, 2022 (AU) 2022901973

(51) Int. Cl. H01M 8/0656; H01M 8/04082; H01M 10/46; H01M 16/00

(52) U.S. Cl. CPC H01M 8/0656; H01M 8/04201; H01M 10/46; H01M 16/006; H01M 2220/10; H01M 2250/10; H01M 2250/402

(57) ABSTRACT

The present invention relates to a method of supplying electricity to an electrical load including steps of providing an alkaline solution, reacting the alkaline solution with silicon so as to produce hydrogen. processing the hydrogen in a fuel cell to generate electricity, and supplying the electricity from an output of the fuel cell to the electrical load via a suitable electrical interfacing module.

### CROSS-REFERENCE TO EARLIER APPLICATIONS

The present application claims priority to Australian Provisional Patent Application No. 2022901973, filed 14 Jul. 2022, the entire disclosure of which is incorporated herein by cross-reference.

### TECHNICAL FIELD

The present invention relates to the field of energy storage and electricity generation using hydrogen as a fuel source.

### BACKGROUND OF THE INVENTION

Any discussion of the prior art throughout this specification should in no way be considered as an admission that such prior art is widely known or forms part of the common general knowledge in the field.

The increased use of renewable energy sources has been considered as a way to decarbonise the modern energy eco-system. However, renewable energy sources are intermittent sources of energy and are incapable of providing stable, consistent and dependable energy supply. Furthermore, certain renewable energies such as solar power will, during the daytime, cause over-generation of electricity calling for demand response to consume the excess electricity. When demand cannot balance supply of electricity, this leads to curtailment (i.e. under-utilisation) of the renewable energy source. By way of example, the world's largest wind farm located in Gansu Province of China operated at only 60% capacity during 2019 to avoid curtailment. Conversely, when the general public returns home from work at the end of the day, this increases distributed energy demand placed on the electrical grid, and it is difficult to meet this increased energy demand as solar energy generation ceases at that time of day. Pumped hydro at present is the only grid scale energy storage solution, but it is limited by geographical locations, reservoir size which directly translates to the length of energy discharge, and seasonality. Hydrogen technologies are being developed, however, problems associated with the cost, safety, scalability, storability and transportability of hydrogen as a grid-scale energy source has meant that fossil fuel and nuclear power still remain as an integral part of the energy eco-system. Thermal Energy Storage is another field that is gaining attention to cope with intermittent sources of energy. Currently, molten-salt TES is the technology most used in the sector due to its advanced technological readiness and its application with concentrated solar power (CSP) plants. According to the US Department of Energy's Global Energy Storage Database, pumped hydro storage accounts for 96% of the world's current storage capacity, with the rest coming from thermal storage (1.6%), electrochemical batteries (1.1%) and mechanical storage (0.9%) (US Department of Energy, n.d.). However, it should be noted that these figures do not include distributed small-scale storage, such as domestic hot-water tanks or batteries.

### SUMMARY OF THE INVENTION

The present invention seeks to alleviate at least one of the above-described problems.

The present invention may involve several broad forms. Embodiments of the present invention may include one or any combination of the different broad forms herein described.

In a first broad form, the present invention provides a method of supplying electricity to an electrical load (such as an electrical grid) including steps of:
(i) providing an alkaline solution;
(ii) reacting the alkaline solution with silicon so as to produce hydrogen;
(iii) processing the hydrogen in a fuel cell to generate electricity;
(iv) supplying the electricity from an output of the fuel cell to the electrical load via a suitable electrical interfacing module.

Preferably, the silicon may include one or more transportable units of silicon.

Preferably, the silicon may include porous silicon.

Preferably, the porous silicon may be produced according to steps of:
(i) alloying silicon with at least one distillable alloying metal such as zinc, magnesium, cadmium, antimony or calcium to form an alloy;
(ii) milling, crushing or grinding the alloy to form alloy pellets or particles in an inert or close to inert environment chamber to prevent/minimize oxidation of the alloy; and
(iii) distilling the alloying metal from the alloy pellets or particles to create a porous structure.

Optionally, after step (iii) a further step may be performed of milling, crushing or grinding the porous silicon structures to break the porous silicon structures apart in to porous silicon particles.

Optionally, after step (iii) a further step may be performed of pressing the porous silicon structured particles can be pressed to form pellets.

Preferably, the present invention may include a step of supplying hydrogen generated by porous silicon to the fuel cell which will then be converted into electricity. This electricity can then be supplied to power various applications and scenarios such as supplying power to an electrical load or grid. Further, the present invention may be utilised for supplying on-demand hydrogen for powering hydrogen electric vehicles which may alleviate the need for pressurised vessels or cryogenic storage and transportation of hydrogen.

Preferably, the present invention may include a step of harnessing the exothermic heat from dissolution of NaOH, hydrogen generation reactions, and heat of fuel cells thereby creating becoming a thermal energy system. This heat can be used to offset power supplies at places where heat is required such as commercial laundry, domestic home heating, aquifer thermal energy storage systems etc.

Preferably, the step of controllably supplying electricity may include using at least some of the electricity from the output of the fuel cell to charge a battery module, and wherein the charged battery module is configured to serve as a buffer between the fuel cell and load; or, is configured to supply a suitable amount of electricity to the electrical load to supplement electricity delivered directly from the output of the fuel cell to the electrical load or application the electrical interfacing module.

Preferably, the battery module may include a fresh battery module or retired EV batteries.

In another broad form, the present invention provides a method of converting electricity received from an electrical source such as from an electrical grid into an energy storage material, the method including steps of:
(i) receiving electricity from the electrical source;
(ii) using the received electricity to conduct a carbothermic reduction of quartz to produce silicon;
wherein said silicon is storable for later use-on-demand to effect release of energy by reacting the silicon with an alkaline solution to produce hydrogen and heat. Preferably, the silicon may be a metallurgical grade silicon or other source of silicon which may have >98% purity to produce the porous particles/pellets/structures as described above. Alternately, instead of quartz, silica may be used in place of quartz in the carbothermic reduction step above.

In another broad form, the present invention provides a system for providing electricity to an electrical load, said system being operable to perform any one of the steps according to the first broad form of the present invention.

In another broad form, the present invention provides a transportable unit of silicon configured for use in accordance with any one of the steps of the first broad form of the present invention.

In another broad form, the present invention creates a grid storage material that can co-generate electricity and heat on-demand.

### BRIEF DESCRIPTION OF THE DRAWINGS

The present invention will become more fully understood from the following detailed description of a preferred but non-limiting embodiments thereof, described in connection with the accompanying drawings, wherein:

FIG. 1 shows a flow chart of method steps for generating electricity from hydrogen that is produced on-demand using porous silicon, whereby the generated electricity is able to support an electrical grid in accordance with an embodiment of the present invention;

FIG. 2 shows a flow chart of method steps for producing porous silicon which may be stored in transportable units and then used to generate the hydrogen on-demand, in accordance with an embodiment of the present invention;

FIG. 3 shows a system for producing the hydrogen from the porous silicon in accordance with an embodiment of the present invention;

FIG. 4 shows a system for producing electricity from the hydrogen for delivery to an electrical grid, and, for charging of battery modules, in accordance with an embodiment of the present invention;

FIG. 5 shows a comparison of hydrogen-producing ability of a porous silicon with that of non-porous, solid silicon; and

FIG. 6 shows an example process schedule for production of hydrogen from porous silicon in a semi-autonomous manner in accordance with an embodiment of the present invention.

### DETAILED DESCRIPTION

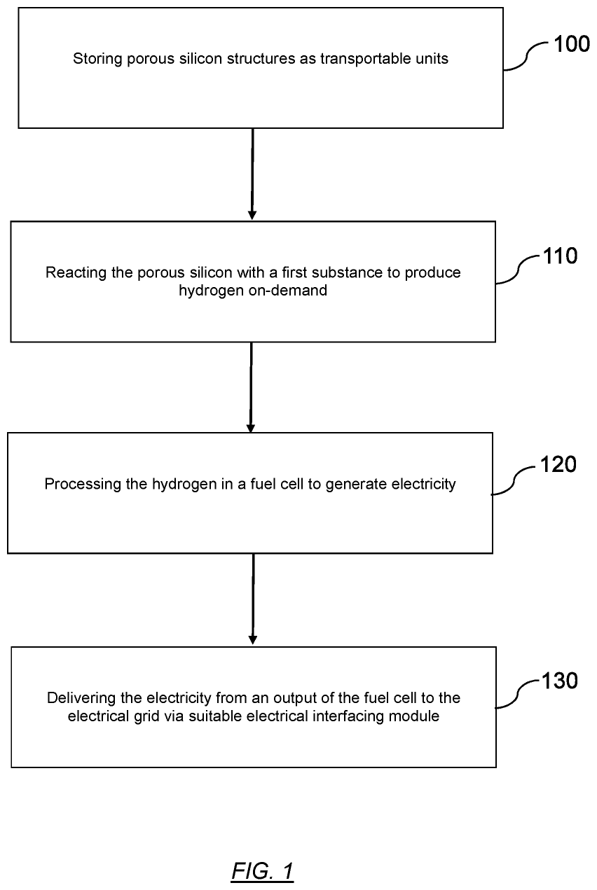

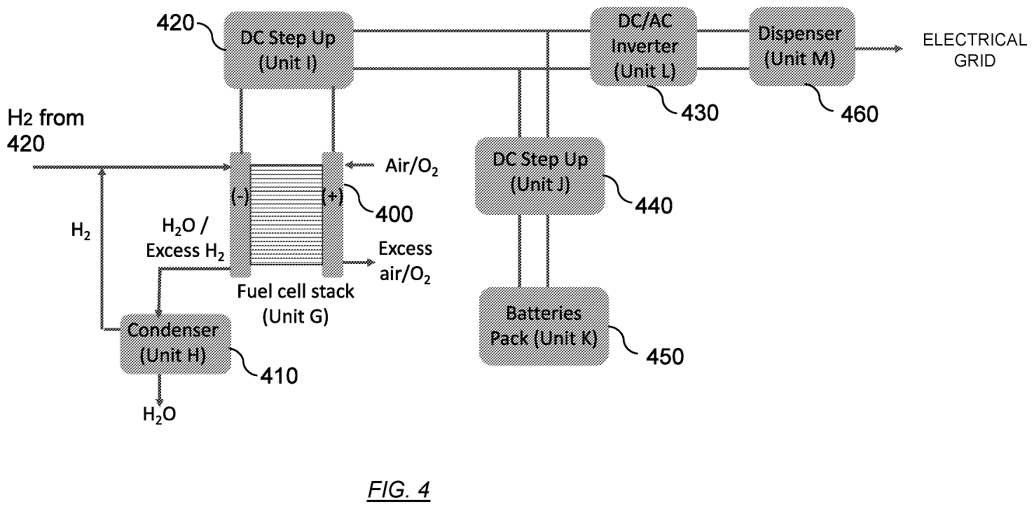

Preferred embodiments of the present invention will now be described herein with reference to FIGS. 1 to 6. The example embodiments describe an exemplary system and method for storing and utilising transportable units of porous silicon (e.g. formed instance, ingots, pellets or other particle structures) to generate hydrogen on-demand, and thereafter, for using the hydrogen to generate electricity for delivery to an electrical load. The exemplary system and method also assists in controlling the amount of electricity that is supplied to an electrical grid by storing some of the electricity that is generated from hydrogen into buffer battery modules (either fresh battery modules or retired EV battery modules), such that electricity from the battery modules may be supplied to the electrical grid at peak periods to assist in meeting load demands placed upon the electrical grid during peak load periods. In these embodiments, the electrical grid may for instance comprise an electrical grid for powering a town or a city, or, may also comprise electrical grids of smaller sizes such as microgrids for instance in powering a home, neighbourhood, building or other smaller scale system.

FIG. 1 shows a flow chart of method steps for supplying electricity to an electrical grid in accordance with one embodiment in which:
(i) an amount of porous silicon is stored in one or more transportable units (100);
(ii) the porous silicon is reacted with an alkaline solution to produce hydrogen (110);
(iii) processing the hydrogen in a fuel cell to generate electricity (120); and
(iv) supplying the electricity from an output of the fuel cell to the electrical grid via suitable electrical interfacing module (130).

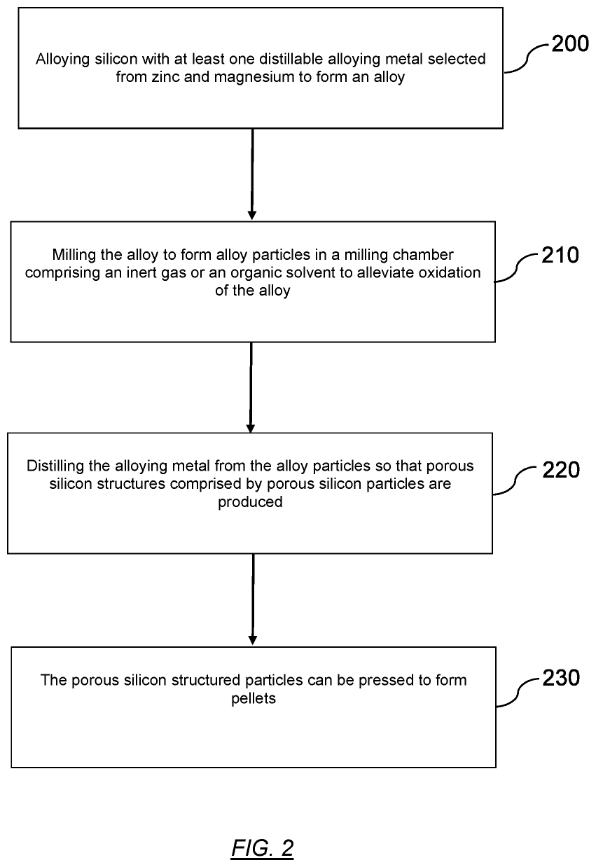

Further, in this example method, the porous silicon that is used to generate hydrogen on-demand is produced in accordance with method steps as shown in the flow chart of FIG. 2 in which:
(i) silicon is alloyed with at least one distillable alloying metal selected from at least one of zinc, magnesium, cadmium, antimony or calcium to form an alloy (200);
(ii) forming alloy pellets, particles or structures in an inert environment chamber to prevent/minimize oxidation of the alloy. Typically the step of forming the alloy pellets, particles or structures may include streps of milling, crushing, or grinding the alloy, atomization, or sintering for instance in certain embodiments, in to alloy particles of around 100 nm to 150 nm diameter;
(iii) the alloying metal is distilled from the alloy particles so that porous silicon structure(s) are produced (220).

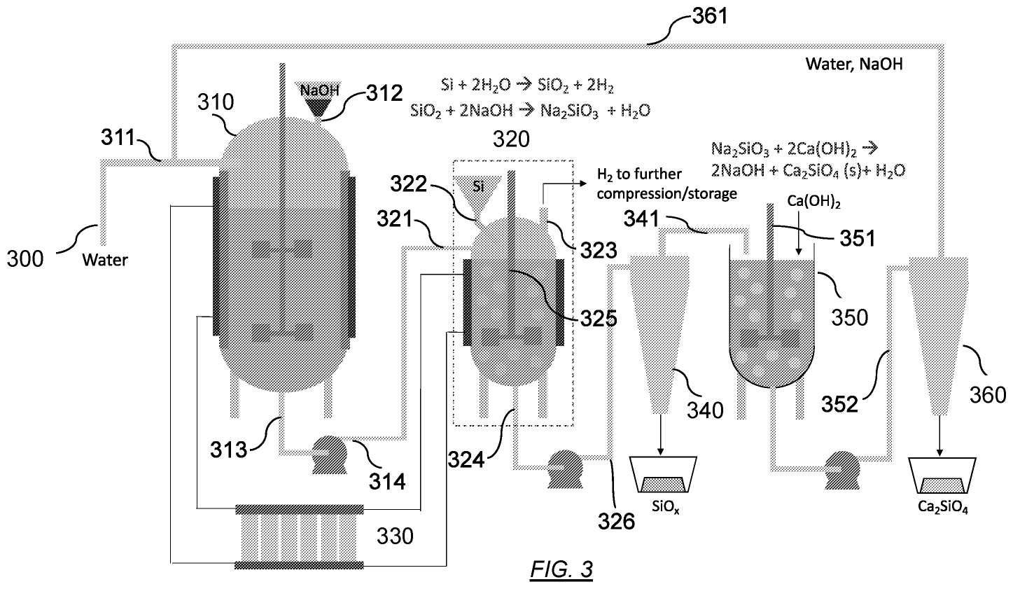

In this example method, hydrogen is produced from porous silicon using a system comprising physical apparatus as shown in FIG. 3. The example closed loop system includes a water supply (300), a caustic dissolution tank (310), a hydrogen reactor (320), a thermoelectric generator (330), a first solid-liquid separator module (340), a precipitation tank (350), and a second solid-liquid separator module (360). The clarified solution from the second solid-liquid separator (360) can be concentrated and recycled back to the caustic dissolution tank (310). The closed loop ensures the maximum preservation of the NaOH and water throughout the H₂ production process. The detailed process is described in further detail below.

### Production of Porous Silicon

In this example embodiment, porous silicon is produced from a raw silicon material. The raw silicon material is firstly alloyed with any alloying metal that is able to be distillable from the alloy using an alloying apparatus, for instance magnesium, zinc, calcium or antimony. This step is represented by (200) in FIG. 2. In these embodiments, the alloying metal in use is magnesium. The process of alloying the magnesium with the raw silicon material is performed under a vacuum conditions or otherwise in a controlled environment since magnesium is extremely flammable at high temperatures. The alloy is formed in proportions of approximately 53% (atomic percent) silicon and 47% magnesium. A different percentage of silicon may be used. However, this ratio can be used to control the size of the final porosity of the silicon grain. Zinc, or a combination of both magnesium and zinc, may also be used as the alloying metal in other embodiments as the alloying metal as the metals are distillable in both situations. Once formed, the alloy will typically be in the form of ingots or other particle structures.

In certain embodiments, it may be possible to form the alloy particles from the liquid melt by use of a metallurgical atomisation process. Conveniently, in accordance with this process, the particle size of the alloy particles can be suitably controlled, and overcoming the issue of magnesium boiling upon solidification, which causes magnesium vapor which solidifies as highly explosive magnesium fine particles.

After forming the alloy particles, preferably from atomization, resulting alloyed particles will be in the range of hundreds of microns. This step is represented by (220) in FIG. 2. Preferably, these micron particles can further undergo a sintering process to form pellets to increase recovery rate of the porous silicon materials from the distillation process. It is understood that the larger the pellet, the longer the distillation time. The distillation process is performed by transferring the alloy particles into a vacuum furnace. The temperature in the vacuum furnace is then raised to distil the alloying metal from the alloy. The distillation temperature has to be controlled below the melting point of the virgin alloy.

The step of distillation advantageously creates pores within the silicon particles and by using different percentages of Mg or Zn (as example, distillable metals) in the alloy, it is possible to control the porosity of the final particles produced. The presence of these pores or increased size and/or increased number of pores in the surfaces of the silicon particles may be particularly useful where the porous silicon particles are reacted with the alkaline solution to produce hydrogen and may produce hydrogen more efficiently than in comparison to the use of non-porous or less-porous silicon particles of similar mass/volume being reacted with the alkaline solution because:
1. Inert processing of the material results in higher bulk elemental silicon vs surface oxide, translating to higher amounts of hydrogen generated as compared to micron/nano sized silicon particles.
2. Since the porosity of the silicon is independent of the size of the particle, the porous silicon particle can be in mm or cm sizes, which has a clear advantage in terms of handling and usage. Small particles may be susceptible to ‘necking’ with different feeding systems.
3. The large surface area of the porous silicon will enable continued and complete reaction with the basic solution where the hydrogen produced can effectively be controlled.
4. Complete reaction of the porous silicon also allows high recovery of the silicate by-products of the hydrogen generation reaction, which significantly lowers the carbon footprint of this porous silicon hydrogen generation system as compared to other forms of hydrogen generation techniques/solutions.

In certain embodiments, a further optional step following distillation may be performed in which the resultant porous silicon particles may be subjected to further processing in a controlled environment to break apart a porous structure comprised of the silicon particles (i.e. by ball milling or by any other suitable process to break down the particle structures in to smaller particles). In these embodiments, the controlled environment includes filling a milling chamber with inert gas such as argon and/or helium, or to a lesser extent nitrogen. The step of distillation advantageously creates pores within the silicon particles and by using different percentages of Mg or Zn (as example, distillable metals) in the alloy, it is possible to control the porosity of the final particles produced. The presence of these pores or increased size and/or increased number of pores in the surfaces of the silicon particles may be particularly useful where the porous silicon particles are reacted with the alkaline solution to produce hydrogen and may produce hydrogen more efficiently than in comparison to the use of non-porous or less-porous silicon particles of similar mass/volume being reacted with the alkaline solution.

In certain alternative embodiments, the process of producing porous silicon particles from a raw silicon material may involve a different sequence of processing steps to that as described above. The raw silicon material is firstly alloyed with an alloying metal such as magnesium or zinc to form alloy ingots or other particle structures. The alloy ingots are distilled to produce porous substantially pure silicon particles/pellets/ingots/structures. Before the alloy ingots are distilled, the ingots may first be processed to form pellets. In certain embodiments the pellets may be around 1 cm in diameter.

The porous silicon particles may be stored in transportable units for processing with water or alkaline solution to produce hydrogen on-demand (as described further below). The porous silicon may be formed as ingots or other mass structures according to suitability for storage and/or transportation. The storability and transportability of silicon solves a key problem hindering the wider scale adoption of hydrogen-based energy source technology in that as silicon may be stored and transported relatively easily, and, as it may be easily reacted with alkaline solution to produce hydrogen which in turn may then be used to generate electricity on-demand.

While a standard blue barrel (42 gallon) of crude oil contains 1670 kWh of exothermic heat upon complete combustion, the retrievable energy stored in porous silicon (packing density ˜50%) at the same volume is 1562 kWh (i.e., 981 kWh as hydrogen by reacting with alkaline solution, and addition 581 kWh as heat). This is much higher than the currently existing leading hydrogen storage solutions, namely, compressed hydrogen (316 kWh at 500 MPa storage), liquefied hydrogen (448 kWh at 21.2 K), high toxic liquefied ammonia (557 kWh at 240 K), solid (zero void) sodium borohydride (663 kWh), and the highly flammable solid magnesium hydride (695 kWh). That is not to mention the readily transportable nature of the porous silicon at ambient conditions without requiring the needs for high pressure compression and cryogenic cooling throughout the transportation and storage process.

Production of Hydrogen from Porous Silicon Particles

In these embodiments, the hydrogen is produced according to a process having steps of:
(a) providing an alkaline solution; and
(b) reacting the alkaline solution with porous silicon to produce hydrogen.

The process may further comprise:
(c) separating solids from the alkaline solution.

The process may further comprise:
(d) separating dissolved silicates from the alkaline solution.

The process may further comprise:
(d1) precipitating dissolved silicates from the alkaline solution to provide precipitated silicates; and
(e) separating the precipitated silicates from the alkaline solution.

The example process involves reacting an alkaline solution with silicon so as to produce hydrogen gas. When using sodium hydroxide to produce the alkaline solution, the following reactions take place in step (b) above:

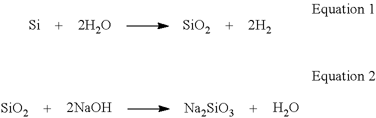

In some embodiments, step (a) may comprise providing the alkaline solution by mixing water with a water-soluble hydroxide, such as for example ammonium hydroxide, lithium hydroxide, sodium hydroxide, potassium hydroxide and cesium hydroxide. The water may be wastewater (such as for example grey water), stormwater, natural surface water (such as for example seawater, lake water or rain water), groundwater, tap water or distilled water.

The alkaline solution in step (a) and/or (b) preferably has a temperature between about 20° C. and about 80° C. In an alternative embodiment, the alkaline solution in step (a) and/or step (b) may have a temperature below 0° C. by making use of the lowered melting point of aqueous caustic solutions, where the eutectic melting point can be as low as −33.4° C. for an alkaline solution containing 20% NaOH. This circumvents the need for antifreeze where the process is performed in a cold environment.

Heat produced during the mixing of water with hydroxide may be used to increase the temperature of the alkaline solution to a desired temperature, the excess of which may be recovered. In some embodiments, the excess heat may be recovered and transferred to a thermoelectric generator, a heat exchanger or some other auxiliary unit that utilises the heat.

Heat produced during reaction of the alkaline solution with the silicon may be used to increase the temperature of the alkaline solution in step (b) to a desired temperature, the excess of which may be recovered. In some embodiments, the excess heat may be recovered and transferred to a thermoelectric generator (330), a heat exchanger or some other auxiliary unit that utilises the heat. In other embodiments, excess heat generated during any part of the process may be recovered via thermoelectric generators. In some embodiments, the silicon is microporous silicon or nanoporous silicon. In one embodiment, the silicon is in the form of micron-sized microporous particles.

Impurities and or dopants to the porous silicon material may beneficially enhance reactivity and/or protecting the porous silicon from mild oxidation.

The extent of reaction and kinetics of the system can be managed by controlling an amount of water, active material, type and concentration of basic/caustic solution, as well as reaction temperature.

In some embodiments the silicon has one or more of the following properties:
A specific surface area (SSA) as determined by N₂ physisorption (BET) of at least 1.5 m²/g, 1.6 m²/g, 1.7 m²/g, 1.8 m²/g, 1.9 m²/g, 2.0 m²/g or 2.1 m²/g, or a surface area between about 2.0 m²/g and about 2.5 m²/g, or between about 2.0 m²/g and about 2.4 m²/g, or between about 2.0 m²/g and about 2.3 m²/g, or between about 2.0 m²/g and about 2.2 m²/g, or between about 2.1 m²/g and about 2.2 m²/g, or between about 1.9 m²/g and about 2.3 m²/g, or about 2.1 m²/g.
An agglomerate particle size distribution having one or more of the following: D10 0.512 μm, D25 1.115 μm, D50 2.305 μm, D75 3.980 μm or D90 5.842 μm.
An average pore volume between about 0.004 mL/g and about 0.007 mL/g, or between about 0.005 mL/g and about 0.006 mL/g, or up to about 0.01 mL/g.
An average pore diameter (4V/A by BET) between about 0.5 nm and about 50 nm, or between about 0.5 nm and about 25 nm, or between about 1 nm and about 20 nm, or between about 10 nm and about 15 nm, or between about 11 nm and about 15 nm, or between about 12 nm and about 15 nm, or between about 12 nm and about 14 nm, or between about 11 nm and about 13 nm, or between about 11 nm and about 12 nm.
A SSA as determined by BET between about 0.85 m²/g and about 2.5 m²/g, correlating to a particle size of 0.5 mm to 5 mm.

Methods for preparing porous silicon that may be used in the process of the disclosure are described in WO2018019266, the disclosure of which is herein incorporated by reference in its entirety.

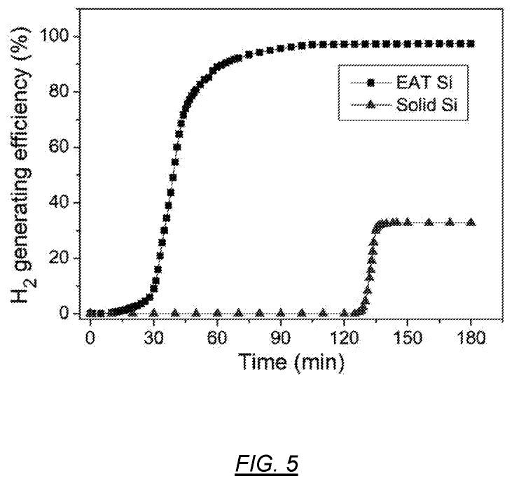

FIG. 5 shows a comparison between the hydrogen-producing ability of a porous silicon (denoted as “EAT-Si”) and a non-porous, solid silicon (denoted as Solid-Si).

The EAT-Si silicon has the following characteristics:
A SSA as determined by N₂-physisorption (BET method) is about 2.1 m²/g, and a particle size distribution as follows: D10 0.512 μm, D25 1.115 μm, D50 2.305 μm, D75 3.980 μm or D90 5.842 μm.
A SSA as determined by N₂-physisorption (BET method) is of about 0.85 m²/g, and a particle size of 5 mm.

Following the reactions shown above in Equations 1 and 2, unreacted solids, such as silicon, undissolved SiOₓ and undissolved silicates (if the dissolved concentration in the liquid exceeds the solubility limit), present in the alkaline solution are removed using a suitable solid-liquid separation technique, such as for example mechanical vapor recompression or distillation, filtration, centrifugation or sedimentation. Solid-liquid separation techniques are well known amongst those skilled in the art. In one embodiment, separation is performed using a hydrocyclone.

In step (d1) dissolved silicates are then precipitated and subsequently separated from the alkaline solution. Precipitation may be achieved by adding a compound or compounds that convert the silicate into a water-insoluble form. In some embodiments, precipitation is achieved by addition of calcium hydroxide or calcium chloride according to Equations 3 and 4 below:

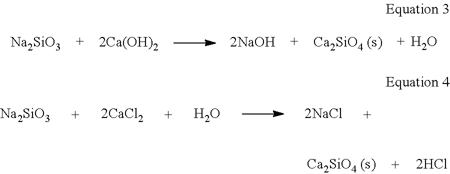

Both reactions lead to the formation of solid Ca₂SiO₄ which precipitates due to its insolubility in water. Precipitation involves low cost and low energy expenditure, thereby contributing to the overall efficiency of the process.

Following any one or more of steps (c), (d) and (e), at least a portion of the alkaline solution may be re-used in step (b). In an alternative embodiment, following step (e), at least a portion of, or all of the alkaline solution may be concentrated to provide water and a concentrated alkaline solution, wherein the concentrated alkaline solution is re-used in step (b). Re-use of the alkaline solution improves process efficiency by preserving water and hydroxide, and also avoids the need for disposal.

The combination of steps (b) and (d1) is possible by introducing Si, aqueous NaOH and solid Ca(OH)₂ in stoichiometric amount based on Eq. 1-3 in the hydrogen reactor as a one-pot reaction. While the H₂ generation kinetics and efficiencies are marginally higher than in step (b) as a result of higher hydroxide concentration as contributed by dissolved Ca(OH)₂, longer incubation time post H₂ generation is required to complete Eq. 3 as limited by the dissolution kinetics of Ca(OH)₂. The resultant Ca₂SiO₄ precipitates can be removed by simple solid-liquid separation as described in step (c) or (e). The advantage of this step lies in the ability to recover aqueous NaOH at or close to the original concentration without needing to reconcentrate.

In an alternative embodiment the alkaline solution may be neutralised as part of step (d1). This may be achieved by equally splitting the alkaline solution into first and second solutions and adding Ca(OH)₂ to the first solution and CaCl₂) to the second solution. The first and second solutions contain NaOH (Eq. 3) and HCl (Eq. 4) respectively in equimolar amounts, which can be combined to neutralize one another (NaOH+HCl->NaCl+H₂O).

The process may further comprise collecting, compressing and storing the hydrogen gas that is produced in step (b). In some embodiments, following step (b), the hydrogen may be stripped of water vapour and/or caustic vapour.

Hydrogen gas is highly flammable and readily forms explosive mixtures with air and oxygen. As such, transportation of hydrogen gas is problematic. The process of the present disclosure allows safe preparation of hydrogen for a given application in situ, thereby avoiding the need for transport. The processes are also environmentally friendly, in that no toxic by-products are produced. In fact, the major by-product of the process (silicates) find use in a number of industries, such as for example as an absorbent, a food additive, a refractory material and a fertilizer additive, to name a few. This adds to the commercial value of the processes.

In another aspect of the disclosure there is provided an apparatus for producing hydrogen, the apparatus comprising:
a caustic dissolution vessel having one or more inlets suitable for introducing water and hydroxide, an inlet of active material such as porous silicon material, and an outlet for exiting an alkaline solution; an inlet for acidic solution to quench the system at emergencies
one or more hydrogen reaction vessels for producing hydrogen having one or more inlets suitable for introducing silicon and the alkaline solution, an outlet for exiting hydrogen produced and an outlet for exiting the alkaline solution, the one or more hydrogen reaction vessels being in fluid communication with the caustic dissolution vessel;
a first solid-liquid separator in fluid communication with the one or more hydrogen reaction vessels for removing unreacted solids present in the alkaline solution received from the one or more hydrogen reaction vessels;
a precipitation vessel in fluid communication with the first solid-liquid separator for precipitating dissolved silicates in the alkaline solution received from the first solid-liquid separator; and
a second solid-liquid separator in fluid communication with the precipitation vessel for separating precipitated silicates from the alkaline solution received from the precipitation vessel.

In some cases, the precipitation vessel can be ‘combined’ with the hydrogen reaction vessels

Referring now to FIG. 3, the apparatus comprises a caustic dissolution vessel (310) having an inlet (311) for introducing water from the water supply (300) and an inlet (312) for introducing hydroxide. The caustic dissolution vessel (310) may be made of an alkaline-resistant material, such as for example stainless steel, and may be fitted with a cooling jacket (not shown). Caustic dissolution vessel (310) further comprises an outlet (313) for exiting alkaline solution and a mechanical stirrer (314). Caustic dissolution vessel (310) is in fluid communication with hydrogen reactor vessel (320) via conduit (314). The hydrogen reactor vessel (320) may be made of an alkaline-resistant material, such as for example stainless steel, and may be fitted with a cooling jacket (not shown). The hydrogen reactor vessel (320) may also comprise a condenser (not shown). Hydrogen reactor vessel (320) comprises inlet (321) for introducing the alkaline solution received from the caustic dissolution vessel (310) and inlet (322) for introducing silicon material. Hydrogen reactor vessel (320) further comprises outlet (323) for exiting hydrogen produced in the hydrogen reactor vessel (320), outlet (324) for exiting the alkaline solution, and a mechanical stirrer (325). The first solid-liquid separator (340) is in fluid communication with hydrogen reactor vessel (320) via conduit (326).

Precipitation vessel (350) is in fluid communication with first solid-liquid separator (340) via conduit (341) and further comprises mechanical stirrer (351). Second solid-liquid separator (360) is in fluid communication with precipitation vessel (350) via conduit (352). The second solid-liquid separator (360) is also in fluid communication with the caustic dissolution vessel (310) via conduit (361). The first and second solid-liquid separators (340,360) may be hydrocyclones, filtration devices, centrifugation devices or sedimentation tanks. The apparatus further comprises thermoelectric generator (330). The apparatus may further comprise pumps (not shown) located between one or more of: the caustic dissolution vessel and the hydrogen reactor vessel, the hydrogen reactor vessel and the first solid-liquid separator and the precipitation vessel and the second solid-liquid separator, for moving the alkaline solution between these components of the apparatus.

In use, water and hydroxide are introduced into caustic dissolution vessel (310) via inlets (311) and (312) respectively. Stirring of the resultant mixture causes dissolution of the hydroxide to provide the alkaline solution and heat. The heat typically maintains the alkaline solution at a temperature of about 50° C. (although temperature and hence reaction kinetics can be tuned accordingly) in the caustic dissolution vessel (310). Excess heat is transported to the thermoelectric generator (330). The alkaline solution exits outlet (313) and travels via conduit (314) through inlet (321) to hydrogen reactor vessel (320). Silicon is introduced to the hydrogen reactor vessel (320) via inlet (322). The reactions noted above in equations 1 and 2 then take place resulting in the formation of hydrogen gas, silicon dioxide and silicate. Hydrogen gas produced exits hydrogen reactor vessel (320) via outlet (323), and may be subsequently compressed and stored. Following the reactions of equations 1 and 2, the resulting alkaline solution exits outlet (324) and travels via conduit (326) to first solid-liquid separator (340). Solid-liquid separator (340) separates unreacted silicon and/or undissolved silicon dioxide from the alkaline solution. The alkaline solution is then transported to precipitation vessel (350) via conduit (341). Precipitation of dissolved silicate is performed in precipitation vessel 350), such as for example, by adding calcium hydroxide and/or calcium chloride to the alkaline solution. The alkaline solution containing the precipitated silicates is then transported to the second solid-liquid separator (360) by conduit (352), wherein the precipitated silicates are separated from the alkaline solution. The resulting alkaline solution is then transported back to the caustic dissolution vessel via conduit (261). In an alternative embodiment, the alkaline solution may be transported back to the hydrogen reactor vessel (320).

In some embodiments, the process may be carried out as a batch process, a semi-batch process, a continuous process, or a semi-continuous process.

### Examples

The present disclosure is further described below by reference to the following non-limiting example.

The following example describes a process in which 150 kg of hydrogen are produced per day using silicon.

Water is combined with NaOH with vigorous stirring in a 1.41 m³ capacity stainless steel tank fitted with a cooling jacket to give a hydroxide concentration of 8.9 M. The production rate of the alkaline solution is maintained at 470 L/h, whereby the exothermic heat of dissolution (0.11 kWh per L solution) is used to maintain the alkaline solution at a temperature of about 50° C. Excess heat of up to 51.7 KW is transferred to a thermoelectric generator.

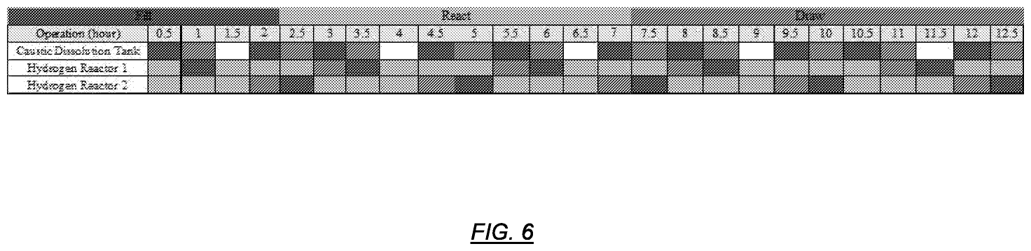

The caustic solution is transferred to a pair of hydrogen reaction vessels having a total capacity of 941 litres. The process is operated in a semi-continuous manner according to the schedule depicted in FIG. 6.

Controlled dispensing of silicon (90 kg per batch) ensures evolution of hydrogen over a reaction period of 1.5 hours. The net exothermic heat of reaction (23.8 kWh per kg H₂) will result in self-heating of the reaction medium in the hydrogen reaction vessels, and this is maintained at the optimum operation condition of about 80° C. Excess heat is transferred to the thermoelectric generator. The hydrogen reaction vessels also include internal condensers in the headspace to condense saturated water vapor (up to 15 kg per batch) that accompanies the hydrogen gas stream leaving the reactor. Operating temperature of the system will largely depend on the ambient temperature.

Unreacted silicon and/or undissolved silicon dioxide is separated from the alkaline solution using a hydrocyclone. The recovered alkaline solution contains dissolved Na₂SiO₃ (up to a concentration of about 3.5 M). The Na₂SiO₃ is precipitated using calcium hydroxide, which results in formation of Ca₂SiO₄. To treat the alkaline solution, a volumetric ratio of saturated calcium hydroxide solution to the clarified solution of 300 is required to precipitate Na₂SiO₃ in its entirety. The stirring speed of the precipitation process is kept low in order to promote the formation of large Ca₂SiO₄ precipitates. The Ca₂SiO₄ precipitates are separated from the alkaline solution using a hydrocyclone. The resulting caustic solution (about 0.032 M) is further concentrated to about 8.9 M and then recycled back to the stainless steel tank.

Generating Electricity from Hydrogen and the Heat from Corresponding Reactions

The generated hydrogen fuel from the above-described process can be conveniently delivered to a fuel cell (400) for direct, on-site electricity generation. Given the ultra-purity grade of the hydrogen stream, i.e., with negligible traces of carbon monoxide, the choice for fuel cells to couple to the process is abundant, ranging from polymer electrolyte fuel cells (PEMFC), alkaline fuel cells, carbonate fuel cells, solid oxide fuel cells, etc. In any case, it is advantageous to employ a low temperature fuel cell, i.e., PEMFC for the benefit of attaining highest conversion efficiency.

Direct electricity production has the advantage of circumventing the needs for high-pressure and/or cryogenic hydrogen storage, which can be costly and hazardous. Instead, the storage as electricity in batteries, whether new or recycled, is a simpler option. Moreover, the use of batteries recycled from EV or other sources may be highly beneficial from the carbon credit perspective.

The production of H₂ in the hydrogen reactor (320) of FIG. 3 can be carried out as on-demand or as semi-steady-state production as described in the above example process. For 75 kg per day of H₂ output from the hydrogen reactor (320) that is fed directly to the anode feed of fuel cell stack, this produces up to 1600 kWh per day, presuming a modest PEMFC efficiency of 64%. A single pass conversion of 50% is assumed here. The mixture of water and unconverted H₂ at the anode outlet stream of the PEMFC is dried by condensation using a condenser (410) and the H₂ is recycled back to the feed. Taking into account of the internal electricity consumption by the entire process including the operation of pumps, heat exchangers, unit operations, and control systems, this would result in net electricity output of more than 1200 kWh per day.

The generated direct current (DC) electricity is able to be stepped up using a DC step-up module (420) and optionally, further converted to 50/60 Hz alternating current (AC, 2- or 3-phase) through a DC/AC inverter (430). A high voltage allows high power and/or multiple charging applications including grid charging, EV charging, and as emergency regenerator.

Additional batteries pack (450) may be placed after the fuel cell stack (400) as an electricity buffer, storing excess electricity (unused by the target application) and supplementing additional electricity (in the case where higher power is required than that output directly from the fuel cell stack (400) to the electrical grid via dispenser module (460)). As mentioned above, the use of recycled batteries can be beneficial in terms of gaining carbon credit. In the case where the amount of generated electricity is more than that required for direct end application, the excess electricity shall be directed to charging of the batteries modules (450). Further stepping up of voltage is provided by DC step-up module (440) which is optional depending on the required voltage for battery charging. At periods of peak loading upon the electrical grid, and where electricity supplied directly from the fuel cell stack (400) to the electrical grid is insufficient to meet peak load requirements, additional electricity may be controllably supplied to the electrical grid from the charged battery modules (450) in order to supplement the electricity supplied by the fuel cell stack (400) so that the electrical grid may meet its peak load requirements.

In another example embodiment, the present invention provides a method of converting electricity received from an electrical source (e.g. curtailed or underutilised electricity from an electrical grid) into an energy storage material. The method may involve using the received electricity to conduct a carbothermic reduction of quartz to produce silicon. Such carbothermic reactions may in some examples consume around 10-12 MWh per tonne of metallurgical grade silicon produced. The carbon source used to perform the carbothermic reaction may include natural or synthetic carbon, including wood chips, coal, coke, or carbonized materials. The produced silicon may be further processed to form a porous silicon which may in some examples consume around 6-9 MWh per tonne of porous silicon produced. As such, in some examples, production of porous silicon from quartz may typically require around 16-21 MWh per tonne. Furthermore, other products such as NaOH may be produced via a chloralkaline process powered by electricity received from the electrical grid. Other products of the chloralkaline process includes, hydrogen and chlorine gas, which may be used to make hydrochloric acid. The porous silicon, NaOH and other products produced using the received electricity from the electrical grid serve as grid storage materials given that they may then be relatively safely and indefinitely stored in an inert/vacuum environment for later on-demand use in order to generate hydrogen, which in turn may be used to generate electricity. More preferably, the received electrical energy that may be converted in to energy stored materials may preferably include curtailed and/or underutilised electricity from an electrical grid. In certain example scenarios 1 kg of porous silicon may be reacted with an alkaline solution to generate around 142.28 grams of hydrogen and 1 kg of hydrogen may be used to generate around 20 kWh of electricity assuming 60% fuel cell efficiency.

Porous silicon will be produced at locations with an overabundance of curtailed electricity, preferably renewable electricity. The energy stored within the porous silicon can be released on-demand when reacted with NaOH (aq) in the form of hydrogen.

Recycled silicon and or scrap silicon from solar cell manufacturers or waste silicon materials from electronic industry can be used as feed material in producing porous silicon. Under this scenario, energy required to produce porous silicon will drop in the range of 60-75%, which results in porous silicon releasing more energy than what is required to produce, leading the way to becoming the world's first carbon negative grid storage material.

The porous structure of the silicon material, if stored in a vacuum or inert environment, will preserve its reactivity indefinitely, which makes porous silicon the ideal grid storage material that is equivalent to barrels of oil.

In addition to generating hydrogen by reacting porous silicon with the alkaline solution, such reaction may also produce heat on-demand. Such heat may be released from dissolution of NaOH into water, producing 1.2-6.88 kWh exothermic heat per kg of H₂ produced, where molar concentrations of NaOH will affect:
a. the composition of the by-product of the hydrogen generating chemical reaction;
b. rate of hydrogen generation.

Continuous oxidation of the porous silicon in basic solution produces hydrogen in any form of chemical reactors, 24 kWh of heat will be released per kg of hydrogen produced. Total heat generated from generating 1 kg of hydrogen thus becomes:

$$Lower limit = 24 + 1.2 = 25.2 kWh$$

$$Upper limit = 24 + 6.88 = 30.88 kWh$$

Round trip energy efficiency of this system, assuming energy used to produce porous silicon from quartz and where electricity is drawn from the grid, i.e. not curtailed electricity, H₂ +thermal energy released, ranges from 45-55%, thereby making it the most efficient transportable and storable energy carrier.

The freezing point of NaOH (aq) depends on its molar concentration, thus at sub-zero temperatures, the available exothermic heat from further dissolution of NaOH will be diminished since the original solution will already be basic to prevent freezing.

For context, a Polymer electrolyte membrane (PEM) electrolyser requires 60 kWh to produce 1 kg hydrogen (including energy consumed to produce deionized water). Energy balance=33.33/60=55%. Hydrogen storage will require ˜4-12 kWh per kg of hydrogen, depending on storage pressure or form, i.e. pressurized or liquified hydrogen, and the amount of hydrogen stored will be limited by the quantity of hydrogen tanks on site. Pumped hydro stations may typically sustain 4 to 16 hours of continuous discharge.

On-demand heat generated from the hydrogen or electricity generation (passing hydrogen through fuel cells to generate electricity electrochemically) process can be utilized to heat up homes, or exert the same function as Aquifer thermal energy storage (ATES) but without the aquifer's water storage tanks, or support commercial dehumidifying systems, to list a few.

### Definitions

The following are some definitions that may be helpful in understanding the description of the present disclosure. These are intended as general definitions and should in no way limit the scope of the present disclosure to those terms alone, but are put forth for a better understanding of the following description.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The terms “a” and “an” are used herein to refer to one or to more than one (i.e. to at least one) of the grammatical object of the article. By way of example, “an element” means one element or more than one element.

In the context of this specification the term “about” is understood to refer to a range of numbers that a person of skill in the art would consider equivalent to the recited value in the context of achieving the same function or result. The term “about” is understood to refer to +/−10% of the recited value.

Any numerical range recited herein is intended to include all sub-ranges of the same numerical precision subsumed within the recited range. For example, a range of 1.0 to 5.0 is intended to include all sub-ranges between (and including) the recited minimum value of 1.0 and the recited maximum value of 5.0, that is, having a minimum value equal to or greater than 1.0 and a maximum value equal to or less than 5.0, such as 2.1 to 4.5. Any maximum numerical limitation recited herein is intended to include all lower numerical limitations subsumed therein and any minimum numerical limitation recited herein is intended to include all higher numerical limitations subsumed therein.

When a component is described to be “fixed”, “coupled”, “attached”, “engaged”, “connected” or the like to another component, it may be directly fixed to the another component or there may be an intermediate component unless expressly or implicitly stated to the contrary. When a component is described to be “disposed” on or in another component, it can be directly disposed on or in another component or there may be an intermediate component unless expressly or implicitly stated to the contrary.

Unless otherwise specified, all technical and scientific terms have the ordinary meaning as commonly understood by persons skilled in the art. The terms used in this disclosure are illustrative rather than limiting. The term “and/or” used in this disclosure means that each and every combination of one or more associated items listed are included.

For the purposes of description, all documents referred to herein are hereby incorporated by reference in their entirety unless otherwise stated.

Those skilled in the art will appreciate that the invention described herein is susceptible to variations and modifications other than those specifically described without departing from the scope of the invention. All such variations and modification which become apparent to persons skilled in the art, should be considered to fall within the spirit and scope of the invention as broadly hereinbefore described. It is to be understood that the invention includes all such variations and modifications. The invention also includes all of the steps and features, referred or indicated in the specification, individually or collectively, and any and all combinations of any two or more of said steps or features.

The reference to any prior art in this specification is not, and should not be taken as, an acknowledgment or any form of suggestion that that prior art forms part of the common general knowledge.

1. A method of supplying electricity to an electrical load including steps of:
(i) providing an alkaline solution;
(ii) reacting the alkaline solution with silicon so as to produce hydrogen;
(iii) processing the hydrogen in a fuel cell to generate electricity;
(iv) supplying the electricity from an output of the fuel cell to the electrical load via a suitable electrical interfacing module.

2. The method as claimed in claim 1, wherein the silicon includes one or more transportable units of silicon.

3. The method as claimed in claim 1, wherein the silicon includes porous silicon.

4. The method as claimed in claim 3, wherein the porous silicon is produced according to steps of:
(i) alloying silicon with at least one distillable alloying metal selected from at least one of zinc, magnesium, calcium and antimony to form an alloy;
(ii) forming alloy pellets or particles in an inert environment to prevent/minimize oxidation of the alloy; and
(iii) distilling the alloying metal from the alloy particles so that porous silicon structures comprised are produced.

5. The method as claimed in claim 1, including a step of controllably supplying electricity from the output of the fuel cell to the electrical load in response to variable load requirements required to power the load.

6. The method as claimed in claim 1, including a step of controllably supplying hydrogen to a compression systems to provide a hydrogen refuelling station.

7. The method as claimed in claim 1, wherein the step of supplying electricity includes using at least some of the electricity from the output of the fuel cell to charge a battery module, and wherein the charged battery module is configured to serve as a buffer between the fuel cell and load, or, is configured to supply a suitable amount of electricity to the electrical load to supplement electricity delivered directly from the output of the fuel cell to the electrical load or application the electrical interfacing module.

8. The method as claimed in claim 1, wherein the battery module includes a fresh battery module or a retired EV battery.

9. The method as claimed in claim 1, wherein the electrical load includes an electrical grid.

10. A method of converting electricity received from an electrical source into an energy storage material, the method including steps of:
(i) receiving electricity from the electrical source; and
(ii) using the received electricity to conduct a carbothermic reduction of quartz to produce silicon;
wherein said silicon is storable for later use-on-demand to effect release of energy by reacting the silicon with an alkaline solution to produce hydrogen and heat.

11. The method as claimed in claim 10, wherein the silicon includes porous silicon.

12. The method as claimed in claim 10, wherein the silicon is stored silicon adapted for transportation.

13. The method as claimed in claim 10, wherein the method further includes a step of using the received electricity to produce NaOH via a chloralkaline process, wherein said NaOH is storable for later use as the alkaline solution which may be reacted with the silicon to generate hydrogen and heat.

14. The method as claimed in claim 10, wherein the electrical source includes an electrical grid.

15. The method as claimed in claim 14, wherein electricity received from the electrical grid includes curtailed or underutilized electricity from the electrical grid.

16. The method as claimed in claim 10, wherein heat is generated on-demand from the hydrogen and/or electricity generation steps.

17. A system for providing electricity to an electrical load, the system comprising:
(i) a means for reacting an alkaline solution with silicon so as to produce hydrogen;
(ii) a means for processing the hydrogen in a fuel cell to generate electricity, wherein the fuel cell includes an electrical output; and
(iii) an electrical interfacing module for supplying the electricity from the output of the fuel cell to the electrical load.

18. A system for converting electricity received from an electrical source into an energy storage material, the system comprising:
(i) a means for receiving electricity from the electrical source;
(ii) a supply of quartz;
(iii) a means for conducting a carbothermic reduction of quartz using the received electricity to produce silicon; and
(iv) a means for storing the silicon for later use-on-demand to effect release of energy by reacting the silicon with an alkaline solution to produce hydrogen and heat.

20. (canceled)
